(19) United States
(12) Patent Application Publication
(10) Pub. No.: US 2006/0222169 A1
(43) Pub. Date: Oct. 5, 2006

(54) Method and system for dialing type conversion in a packetcable CPE device

(76) Inventors: Rickey Lee Morris, Dacula, GA (US); William Charles Hare JR., Cumming, GA (US)

Correspondence Address: ARRIS INTERNATIONAL, INC, 3871 LAKEFIELD DRIVE, SUWANEE, GA, 30024, US

(21) Appl. No.: 11/396,123

(22) Filed: Mar. 30, 2006

Related U.S. Application Data
(60) Provisional application No. 60/666,347, filed on Mar. 30, 2005.

(51) Int. Cl. H04M 1/00

(52) U.S. Cl. 379/355.01

(57) ABSTRACT

Digits dialed using a pulse dialing device, such as a rotary phone or pulse-based alarm system, are detected by an MTA device that has been configured using an MIB object in the MTA configuration file. Upon detection the MTA generates a DTMF signal, or RFC2833 digit event, and forwards the DTMF signal or RFC2833 digit event corresponding to the dialed digit toward a communication network.

### CROSS REFERENCE TO RELATED APPLICATION

This application claims priority under 35 U.S.C. 119(e) to U.S. provisional patent application No. 60/666,347 entitled “Dialing method conversions in a PacketCable-defined CPE device”, which was filed Mar. 30, 2005, and is incorporated herein by reference in its entirety.

### FIELD OF THE INVENTION

The present invention relates generally to broadband communication, and more particularly to a method converting pulse dial signals to tone dial signals.

### BACKGROUND

Community antenna television (“CATV”) networks have been used for more then four decades to deliver television programming to a large number of subscribers. Increasingly, CATV networks are used by providers to provide data services to subscribers. For example, cable modems used in a broadband cable modem termination system (“CMTS”) are capable of transmitting and receiving Internet data using the Data Over Cable Service Interface Specification (“DOCSIS”) protocol. DOCSIS provides a standard that allows network devices made by different vendors to communication with one another.

Similar to DOCSIS, which is administered by Cable Television Laboratories, Inc. (CableLabs®), “PacketCable™ is a CableLabs-led initiative aimed at developing interoperable interface specifications for delivering advanced, real-time multimedia services over two-way cable plant. Built on top of the industry's highly successful cable modem infrastructure, PacketCable networks use Internet protocol (IP) technology to enable a wide range of multimedia services, such as IP telephony, multimedia conferencing, interactive gaming, and general multimedia applications.” See www.packetcable.com. DOCSIS and PacketCable are protocol standards known in the art and do not require further discussion of the basic functioning thereof. However, it will be appreciated that, although DOCSIS and PacketCable are currently considered industry standards, other protocol standards may become predominant over time. Thus, for purposes of discussion herein, DOCSIS may be generically referred to as a ‘data protocol’ and PacketCable as a ‘multimedia protocol.’

As with many other technologies, consumer subscriptions to telephony services that are provided over a network other than the public switched telephony network (“PSTN”) are increasing. However, some consumers may not want to purchase new telephone handsets, although they may otherwise wish to subscribe to telephony over cable service, PacketCable, for example. In some of these cases, the consumers' telephone sets may not be capable of tone dialing, or dual tone multi frequency (“DTMF”) dialing. Equipment not capable of DTMF dialing is typically referred to as pulse dialing equipment, and example of which may include a telephone set having a rotary dial for a user to input digits when dialing another telephone number. Another example of such equipment is a pulse dialing enabled alarm system board.

In currently available implementations, detected pulse dialed digits are not communicated directly to the telephony switch, such as a class 5 telephony switch. The RFC2833 protocol may be used to communicate each on/off hook transition to the PSTN gateway. The PSTN gateway then reproduces the on-hook, off-hook transitions toward the Class 5 switch. The class 5 switch then interprets the pulses in real time to determine the dialed digits. Latency, jitter and packet loss introduced by the network can negatively affect the relative timing of each pulse and thus render digit detection very difficult. These factors make this approach impracticable due to the strict timing requirements of pulse dialing.

Another approach has been to have the Multimedia Terminal Adaptor (“MTA”) interpret the pulse dialed digits, relay the information via NCS to a signaling (such as PSTN) gateway device, and then have the gateway device communicate the dialed digits to the Class 5 switch. However, this approach not only introduces delay with each dialed digit, but is also problematic because there is no specified mechanism for the gateway to communicate dialed digits directly to the Class 5 switch.

Thus, there is a need in the art for a method and system for providing pulse dialing support for telephony services over networks other than the PSTN.

### SUMMARY

A method for converting dialed digit pulse signals into tone digit signals includes having an MTA detect the pulse dialed digits, and then generate DTMF tones. These generated tones are relayed directly to the telephony switch by in-band signaling. This DTMF in-band tone relay feature not only alleviates delay conditions introduced by the other options, but also allows a call management server (“CMS”), PSTN gateway and switch to operate as if the dialing device is generating DTMF tones. Furthermore, if the CMS enables RFC2833 Digit Events on the MTA, the pulse dialed digits can be converted to RFC2833 events and relayed in-band towards the network for increased reliability. This invention also allows operators to charge their subscribers a differential service fee to enable pulse dialing devices.

### BRIEF DESCRIPTION OF THE DRAWINGS

FIG. 1 illustrates a network configuration with a PSTN Gateway.

FIG. 2 illustrates a network configuration with a CMS.

FIG. 3 illustrates a flow diagram of a method for placing calls using pulse dial equipment and in-band signaling over a network with a signaling gateway.

FIG. 4 illustrates a flow diagram of a method for placing calls using pulse dial equipment and RFC2833 messages over a network with a signaling gateway.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

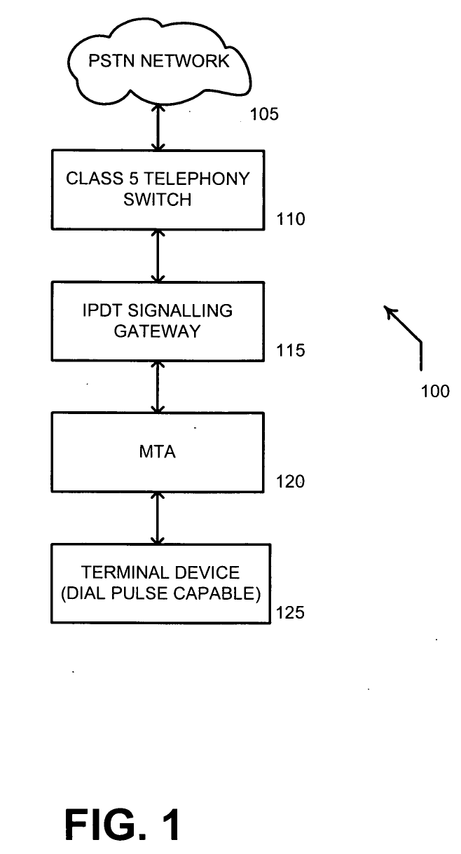

Turning now to the figures, FIG. 1 illustrates a network system 100 for providing Voice over an IP network (“VoIP”). During a call initiation sequence, a call is placed when terminal device 125, such as a dial-pulse telephone, goes off-hook. MTA 120 detects the off-hook and notifies IPDT Signaling gateway 115. Gateway 115 then notifies the Class 5 Telephony switch 110. Switch 110 then sends dial tone down to MTA 120 and prepares to accept DTMF addressing information from MTA 120. Once the switch has received and decoded the DTMF addressing information, the call is put through.

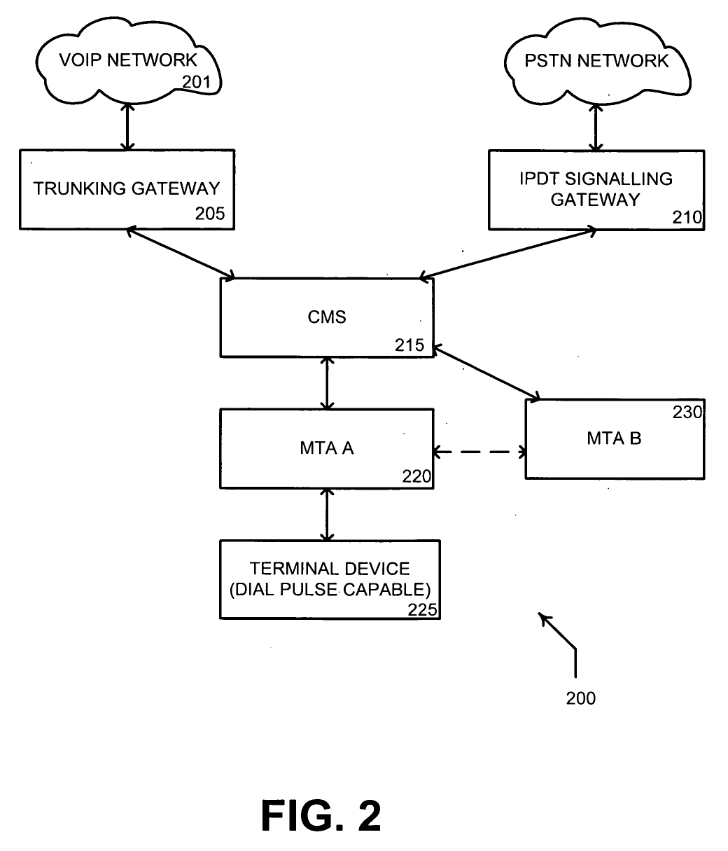

FIG. 2 illustrates another network system configuration 200 for a Vo IP network. During a call initiation sequence, a call is placed when terminal device 225 goes off-hook. MTA A 220 detects the off-hook and notifies Call management Server (“CMS”) 215. CMS 215 then sends a message that requests that MTA A 220 send dial tone and collect the dialed digits from terminal device 225. After MTA 220 has collected the required addressing information it sends a message to CMS 215 with the addressing information. CMS 215 decodes the addressing information and potentially directs MTA 220 to connect to another MTA, such as MTA B 230, or CMS 215 can connect the call through trunking gateway 205, or through gateway 210.

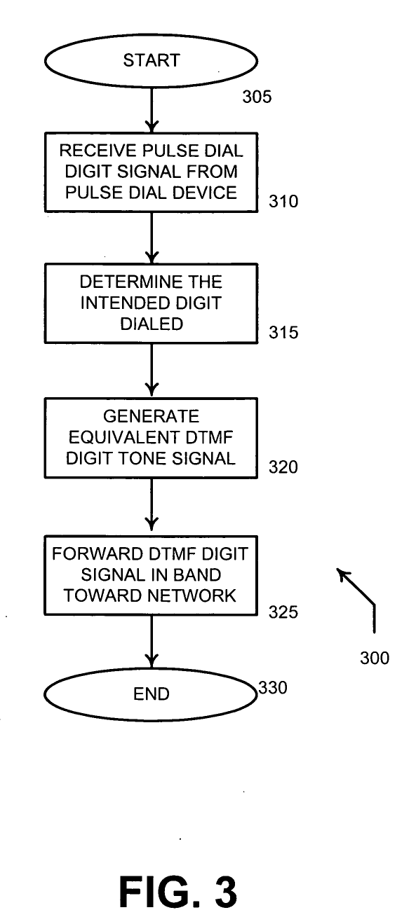

Turning now to FIG. 3, a flow diagram of a method 300 for placing calls using pulse dial equipment over a tone dialing network is illustrated. Method 300 starts at step 305 when a user attempts to place a telephone call to a device associated with another telephone number by dialing a digit of the telephone number to be called. If the user is a subscriber to telephony services over cable, such as PacketCable, for example, the user device typically comprises an MTA. At step 310 the MTA receives the dialed digit signal pulse. The MTA detects that the incoming signal is a pulsed digit signal at step 315 by analyzing the incoming pulse signal according to known methods. Based on the number of pulses in a single digit pulse-signal, a corresponding tone signal is generated based on a mapping of tone signal frequency(ies) to number of pulses. Such techniques are known in the art.

The MTA generates a DTMF tone signal corresponding to the dialed digit at step 320 and sends it to the PSTN gateway at step 325 within the voice band, often referred to in the art as ‘in-band’. The dialed digits are sent in-band so the switch and call processing devices in the network need not be modified to accommodate the user with a pulse dial device. The process ends at step 330.

It will be appreciated that the DTMF tones are transmitted to the PSTN gateway via the RTP connection or stream. The tone frequencies, level and duration of the DTMF tones are all within Telcordia specifications for DTMF digit generation and will thus be detected as such by any compliant DTMF detector (such as that on a Class 5 switch). This will enable the switch to process dialed digits as if the dialed digit(s) originated from a DTMF device. Since the switch will be receiving DTMF digits instead of pulse dialing information, it should be configured as such. This aspect of the invention is typically not applied in CMS controlled (i.e. non-IPDT) solutions. In such a configuration, dialed digits are notified to the CMS. Therefore, there is no need to also relay them in-band.

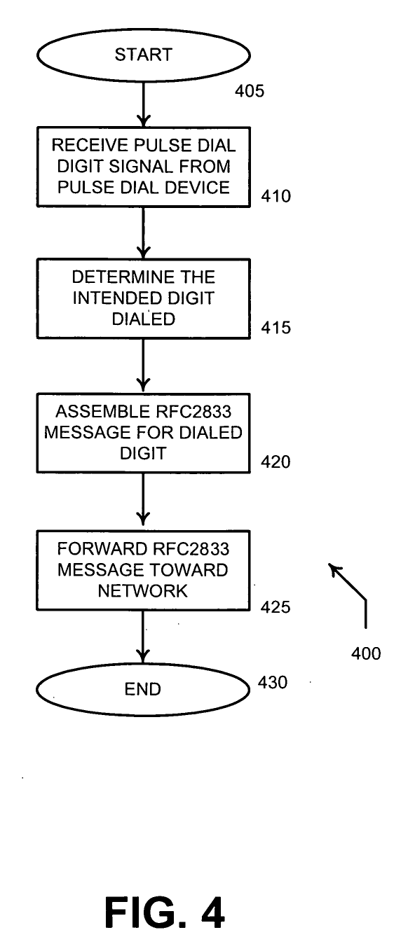

It is noted that RFC2833 may also be used to relay digit information to the far end if requested by the CMS. As long as pulse dialing is enabled, a pulse dialed digit may be relayed using RFC2833 when requested, as is currently done with DTMF dialed digits. The steps shown in the flow diagram illustrated in FIG. 4 are similar to corresponding steps in FIG. 3, with the exception of step 420 of FIG. 4 as compared to step 320 from FIG. 3. As described above, at step 320, a detected digit is used to generate an equivalent DTMF digit tone signal before sending toward the network at step 325. In FIG. 4, a detected dialed digit is used to assemble a RFC2833 message corresponding to the dialed digit at step 420 before the RFC2833 message is forwarded toward the network at step 425. It will be appreciated that the network toward which either a DTMF signal or a RFC2833, as described above in reference to FIGS. 3 and 4 respectively, may be either a PSTN network or a VoIP network.

An MTA at a customer premise may support multiple scenarios as listed in the following table.

TABLE 1
Potential MTA Dialing Settings

| Scenario | Dialing Method | Description |
|---|---|---|
| 1 | Tone | Enables DTMF tone |
| | | detection only. |
| 2 | Pulse | Enables pulse dialing |
| | | detection only. |
| 3 | Tone & Pulse | Enables both DTMF |
| | | tone and pulse dialing |
| | | detection. |
| 4 | Pulse w/DTMF Relay | Enables pulse dialing |
| | | detection with DTMF |
| | | in-band relay enabled. |
| 5 | Tone & Pulse w/DTMF | Enables both DTMF |
| | Relay | tone and pulse dialing |
| | | detection with DTMF |
| | | in-band relay enabled. |

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for setting up telephony calls originating from pulse dial equipment over a telephony network, comprising:
receiving a dial-pulse-digit signal from dial pulse terminal equipment;
analyzing the dial-pulse-digit signal to determine the intended dialed digit;
generating a dual-tone-multi-frequency-digit signal corresponding to the intended dialed digit; and
inserting the dual-tone-multi-frequency-digit signal into the outgoing channel toward the network.

2. The method of claim 1 wherein the analyzing, generating and inserting steps may be disabled based on a command.

3. A method for setting up telephony calls originating from pulse dial equipment over a communication network, comprising:
receiving a dial-pulse-digit signal from dial pulse terminal equipment;
analyzing the dial-pulse-digit signal to determine the intended dialed digit;
generating a message signal corresponding to the intended dialed digit; and
transmitting the message signal out of band toward the network.

4. The method of claim 3 wherein the analyzing, generating and transmitting steps may be disabled based on a command.

5. The method of claim 3 wherein the message signal includes RFC2833 digit event.
